(19) United States
(12) Patent Application Publication
(10) Pub. No.: US 2012/0103614 A1
(43) Pub. Date: May 3, 2012

(54) Method of Treating a Borehole and Drilling Fluid

(75) Inventors: Roland Kalb, Leoben (AT); Herbert Hofstätter, Vocklabruck (AT)

(73) Assignee: MONTANUNIVERSITAT LEOBEN, Leoben (AT)

(21) Appl. No.: 13/257,302

(22) PCT Filed: Mar. 17, 2010
(86) PCT No.: PCT/EP10/53482

§ 371 Date: Nov. 29, 2011

(30) Foreign Application Priority Data
Mar. 18, 2009 (EP) 09003908.2

(51) Int. Cl. E21B 43/16; C09K 8/02

(52) U.S. Cl. 166/305.1; 507/100

(57) ABSTRACT

A method of treating a borehole is provided, wherein the method comprises introducing a drilling fluid into a borehole, wherein the drilling fluid comprises an ionic liquid. In particular, the ionic liquid may comprise a single ionic liquid, i.e., only one kind of anion and one kind of cation, or may comprise a mixture of different ionic liquids, e.g., may comprise several different anions and/or several different cations.

### FIELD OF THE INVENTION

The invention relates to a method of drilling and treating a borehole.

Further, the invention relates to a drilling fluid.

### BACKGROUND OF THE INVENTION

In drilling of wells for hydrocarbons such as oil and/or gas from subterranean deposits or in drilling for geothermal energy, it is common practice to use a rotary drilling procedure in which a drill bit is rotated at the bottom of the bore hole by means of rotating hollow drill pipe which extends to the surface. The drill pipe is driven from the surface and a circulating fluid commonly referred to as a drilling fluid or drilling mud is pumped through the drill pipe where it emerges through openings in the drill bit to cool the same and is returned to the surface in the annular space between the drill pipe and the walls of the bore hole. The bit might also be rotated by a downhole motor which is powered by the drilling fluid as well.

The drilling fluid, upon emerging from the well at the surface, may be mechanically and/or chemically processed to remove the cuttings and other undesirable contaminants and is normally treated chemically to maintain certain chemical and physical properties of the fluid depending upon particular drilling conditions encountered. The drilling fluid after being reconstituted is normally recirculated by pumps to be forced downwardly through the drill pipe, this circulation being generally continuous during drilling. Circulation of the drilling fluid may be interrupted occasionally such as when an additional section of drill pipe is added at the top of the string of pipe or when the entire length of drill pipe is withdrawn to replace or repair the drill bit.

The drilling fluid may be capable of performing many varied functions which are required in a successful drilling procedure and therefore may possess certain desirable chemical and physical properties. The drilling fluid may have sufficient viscosity to suspend and remove the cuttings from the bore hole and may have sufficient gel strength to hold solids in suspension, especially when circulation of the fluid is interrupted. It also may have sufficient density to exert suitable pressure to the sides of the bore hole to prevent the entrance of fluids into the bore hole from the earth formation being penetrated, and it may have low fluid loss to prevent undue loss of fluid into the formation by its deposition on the bore hole sides such as by forming an impervious filter cake or deposit. Furthermore, a dense drilling fluid may be used to compensate for the pressure the borehole is exposed to by the surrounding earth formation. In general weighting agents are used, e.g. CaCl₂, CaCO₃, BaSO₄, Fe₂O₃ or the like. However, these inert substances may tend to separate or to precipitate from the drilling fluid, in particular when used in high concentrations. This may lead to safety-related problems during the drilling, e.g. since the flow of the drilling fluid may stop, the drill bit may jam in the borehole, or the weighting agents may already separate in a reservoir before pumped into the borehole. This separation problem will particularly occur in case no shearing force is applied to the drilling fluid or the circulation of the drilling fluid in the borehole is stopped. Although the rheologic characteristics of the drilling fluid may be adjusted by additives, e.g. polymers, such additives tend to have a limited temperature stability.

Thus, there may be a need to provide an alternative drilling fluid.

### OBJECT AND SUMMARY OF THE INVENTION

It may be an objective of the present invention to provide an alternative method of treating a borehole and an alternative drilling fluid for treating a borehole, which may have a high density while having a low amount of weighting agents so that a decreased tendency to separate may be achievable.

This object may be solved by a method of treating a borehole and a drilling fluid according to the independent claims. Further exemplary embodiments are described in the dependent claims.

According to an exemplary aspect of the invention a method of treating a borehole is provided, wherein the method comprises introducing a drilling fluid into a borehole, wherein the drilling fluid comprises an ionic liquid. In particular, the ionic liquid may comprise a single ionic liquid, i.e. only one kind of anion and one kind of cation, or may comprise a mixture of different ionic liquids, e.g. may comprise several different anions and/or several different cations. For example, the ionic liquid may not only be a trace material but may form a constituent of the drilling fluid which may be a main component. Thus, the drilling fluid may be an ionic liquid based drilling fluid.

According to an exemplary aspect of the invention a drilling fluid is provided which is based on ionic liquid.

The term “ionic liquid” may particularly include all liquid organic salts and mixtures of salts consisting of organic cations, organic anions or inorganic anions. Moreover additional salts or small amounts of additives may be dissolved in the ionic liquid. Furthermore, the ionic liquids may have a melting point of less than 250° C. and in particular, less than 200° C. and preferably less than 100° C. According to the generally accepted literature (e.g. Wasserscheid, Peter; Welton, Tom (Eds.); “Ionic Liquids in Synthesis”, Wiley-VCH 2008; ISBN 978-3-527-31239-9) Ionic Liquids are melts of low melting salts with melting points equal or below 100° C. However, the melting temperature of 100° C. is chosen arbitrarily by definition, therefore according to this application salts with melting temperatures >100° C. but <250° C. are included as well.

The term “based on an ionic liquid” may particularly denote the fact that a main component, e.g. the component which is the single component of the drilling fluid having the highest percentage, is an ionic liquid or is formed by a mixture of ionic liquids. That is, a drilling fluid based on ionic liquid is to be distinguished from a water based ionic liquid and an oil based ionic liquid in which water and oil, respectively forms the main component. For example, the amount of water and/or oil in the drilling fluid may be less than that of the ionic liquid, i.e. the amount of water and/or oil will be less than 20%, preferably less than 10% or even less than 5%. For example, the drilling fluid may be waterfree and/or oilfree, i.e. only traces of water and/or oil may be present in the drilling fluid.

The use of a drilling fluid having as one constituent an ionic liquid may enable to increase the density of the drilling fluid since ionic liquids may have a higher density than water and oil which are the known base materials for drilling fluids. Thus, the use of a drilling fluid based on ionic liquid or having at least an ionic liquid as constituent may enable to design a drilling fluid which needs no weighting agents in order to achieve a suitable density. Thus, it may also be possible to omit further additives, like polymeric additives, which are used in water and oil based drilling fluids to increase the amount of weighting agents which can be used in the drilling fluid. Additionally, the omitting of the additives may also increase the temperature stability since these additives tend to decrease the temperature stability. Another possible advantage of a drilling fluid having an ionic liquid as constituent may be that the solubility of gases in the drilling fluid may be reduced. In particular, oil based drilling fluids tend to outgas dissolved gases when pumped back to the surface which may lead to the fact that the column of drilling fluid becomes lighter leading to instabilities of the walls of the borehole or may lead to water penetrating into the borehole. Furthermore, the possible omitting of water in the drilling fluid may reduce the risk of clay swelling. For the sake of clarity it should be noted that the term “additive” may particularly denote substances added to the main components in a small amount, e.g. below 2.5% or even below 1%.

Next, further aspects of exemplary embodiments of the method of treating a borehole are described. However, these embodiments also apply for the drilling fluid.

According to an exemplary embodiment of the method the drilling fluid comprises at least 20 mass percent of ionic liquid. In particular, the drilling fluid may comprise at least 50 mass percent of ionic liquid. Particularly, the drilling fluid may comprise at least 80 mass percent of ionic liquid. Alternatively, the drilling fluid may comprise at least 15 mass percent or at least 16 mass percent of ionic liquid. These amounts or fractions of ionic liquid in the drilling fluid may be sufficient to provide advantageous effects. That is, the ionic liquid may not only form an additive which is added in traces or to a very small amount but may form at least a main constituent of the ionic liquid. In particular, the drilling fluid may neither be a water-based drilling fluid nor an oil-based drilling fluid but an ionic-liquid based drilling fluid.

According to an exemplary embodiment of the method the drilling fluid comprises at least 95 mass percent of ionic liquid. In particular, the drilling fluid may be formed by a pure ionic liquid or substantially pure ionic liquid, i.e. other components may only be present in traces, e.g. each in an amount of less than 1 mass percent. For example, no additionally weighting agents may be present. That is, the drilling fluid may essentially only contain ions (anions and cations).

According to an exemplary embodiment of the method the ionic liquid has a density of more than 1.5. In particular, the ionic liquid may have a density of more than 2.0 and preferably more than 2.5. Furthermore, the density of the total drilling fluid may be more than 1.5, in particular more than 2.0, more particularly more than 2.5 and preferably equal or more than 2.7. For example, the density of the ionic liquid may be adjusted by using heavy elements, e.g. elements having a higher atomic number than Oxygen, like iron, when designing the anion or even the cation. Suitable elements for the anion may be generally F, Cl, Br, I, S, P and Si. These elements may be bound to C of e.g. alkyl side chains or aromatic groups or may form a complex with metals, e.g. Ti, V, Cr, Mn, Fe, Co, Ni, Cu, Zn, Mo, W, Sn, Al, and/or Pb. Additionally, O and/or N may be bound to these elements, e.g. in case of S, P, Mo, W, Sn, or Al. Alternatively or additionally organic or inorganic salts may be solved or dispersed in the ionic liquid, wherein the organic or inorganic salts may have a high melting point, i.e. higher than 250° or at least higher than the ionic liquid in which they are dissolved or dispersed. Moreover, the drilling fluid or the ionic liquid itself may comprise micro- and/or nano-particles which may not be solvable in the ionic liquid, which particles may have a high density, e.g. above 2.5 and/or which may have a chemically modified surface, so that they are stabilized in the ionic liquid, e.g. by chemically or physically modifying the surface by using organic groups. These particles may comprise at least one out of the materials of the group consisting of BaSO₄, Fe₂O₃, CaCO₃, metal oxides or semi metal oxides, e.g. SiO₂, TiO₂, Al₂O₃, Fe₂O₃, Fe₃O₄, ZnO, zeolite, silicon, metals, e.g. Ti, V, Cr, Mn, Fe, Co, Ni, Cu, Zn, Mo, W, Sn, In, Sb, Al, Pb, metal sulfides, metal carbides, metal nitrides, and silicon compound, e.g. mesoporous materials like MCM-41 or SBA-15.

Possible anions may be e.g. halometallates like tetrachloroferrate, tetrabromoferrate or tetrafluoroferrate.

In particular, the use of ionic liquids and/or drilling fluids having such a high density may enable to increase the maximum depth of the borehole, since the pressure imposed by such drilling fluids may be higher than that of known drilling fluids. The increase of the maximum depth may be advantageous, e.g. by increasing the resources of oil and gas which are accessible.

According to an exemplary embodiment the method further comprises removing the drilling fluid out of the borehole, reconditioning the removed drilling fluid, and introducing the reconditioned drilling fluid in the borehole.

That is, the drilling fluid may be recycled by removing the drilling fluid together with contaminants, e.g. cuttings, out of the borehole, removing the contaminants from the drilling fluid, e.g. filtering or cleaning the contaminated drilling fluid, and introduce or refill the cleaned drilling fluid again.

According to an exemplary embodiment of the method the drilling fluid has a temperature stability which is higher than a predetermined threshold value. In particular, the predetermined threshold value may be 150° C., more particularly the predetermined threshold value may be 250° C. and preferably 300° C. Even higher temperature stability values, like more than 350° C. may be possible. For example, the temperature stability may be adjusted by adapting or designing the temperature stability of the ionic liquid. For example, the temperature stability of the ionic liquid may be adjusted by selecting an anion of higher and lower nucleophilic value or alkalinity which is associated with a lower and higher temperature stability, respectively e.g. trifluoromethanesulfonate.

According to an exemplary embodiment of the method the drilling fluid has a water absorption capability which is lower than a predetermined threshold value.

In particular, the predetermined threshold value may correspond or may be equal to a water absorption capability or water uptake capability of 5 mass % or less, preferably of 1 mass % or less. This may be achieved by adding unpolar, water immiscible molecular co-solvents like saturated, unsaturated or aromatic hydrocarbons, ethers, esters, ketones, aldehydes, nitriles etc. It may be achieved as well by choosing ionic liquids with long, C4 to C20 alkyl-, alkenyl or cycloalkyl side chains, bound to the anion, cation or both. These side chains may be fluorinated or chlorinated as well. It may independently or additionally be achieved as well by choosing hydrophobic anions like hexafluorophosphate, tetrafluoroborate, tris(perfluoroalkyl)trifluorophosphate (“FAP”=fluorous alkyl phosphate), bis(trifluoromethylsulfonyl)imide (“BTA” or “TFSI”), or some halometallates e.g. tetrachloroferrate, tetrabromoferrate.

According to an exemplary embodiment the ionic liquid satisfies the generic formula ([A]⁺)ₐ[B]a⁻, wherein [A]⁺ is one out the group consisting of quaternary ammonium cation [R^{1′}R¹R²R³N]⁺, phosphonium [R^{1′}R¹R²R³P]⁺, sulfonium [R^{1′}R¹R²S]⁺ and a hetero aromatic cation. In particular, R¹, R^{1′}, R², R³ may be alkyl, alkenyl, alkinyl, cycloalkyl, cycloalkenyl, aryl or heteroaryl which may be independently substituted, or two of the moieties R¹, R^{1′}, R², R³ may form a ring together with a hetero-atom to which they are bound. The ring may be saturated, unsaturated, substituted or unsubstituted. The chain may be interrupted by one or more hetero-atoms out of the group consisting of O, S, NH or N—C₁C₄-alkyl, and [B]^{a-} may be an arbitrarily chosen anion having negative charge a.

Summarizing, according to an exemplary aspect of the invention, a drilling fluid is provided which is based on an ionic liquid or a mixture of ionic liquids. Such an ionic liquid based drilling fluid may be designable according to the needs of the specific drilling. For example, dense ionic liquids may be used having a density above 2.5 leading to the effect that no additional weighting agents are necessary or drilling fluids based on ionic liquids having a high temperature stability may be used. In particular, several characteristics of the ionic liquid and thus of the drilling fluid may be adjusted to the specific needs by just choosing appropriate anions and/or cations for the ionic liquid. Due to the wide design possibilities of ionic liquids it may be possible to provide ionic liquids which do not react with the rock or stone surrounding the borehole or with crystal water contained therein. It may be possible to ensure that no emulsions of the ionic liquid and oil may be formed which may be difficult to separate afterwards. Additionally the ionic liquid may be chosen to have a high heat capacity, high heat conductivity, a high hydrolysis resistance, and/or a permanent temperature stability of more than 120° C., in particular more than 250° C. or even more than 300° C. Moreover, such ionic liquids may have a low gas solubility, in particular with respect to methane, e.g. less than 10 norm m³ per m³ of ionic liquid at 300 bar or 3*10⁵ hPa and 100° C., in particular less than 1 norm m³ per m³ of ionic liquid at 300 bar or 3*10⁵ hPa and 100° C., and preferably less than 0.1 norm m³ per m³ of ionic liquid at 300 bar or 3*10⁵ hPa and 100° C.

The aspects defined above and further aspects of the invention are apparent from the examples of embodiment to be described hereinafter and are explained with reference to these examples of embodiment. It should be noted that features described in connection with one exemplary embodiment or exemplary aspect may be combined with other exemplary embodiments and other exemplary aspects.

### BRIEF DESCRIPTION OF THE DRAWINGS

The invention will be described in more detail hereinafter with reference to examples of embodiment but to which the invention is not limited.

FIG. 1 schematically illustrates a drill rig.

### DESCRIPTION OF EMBODIMENTS

The illustration in the drawing is schematically.

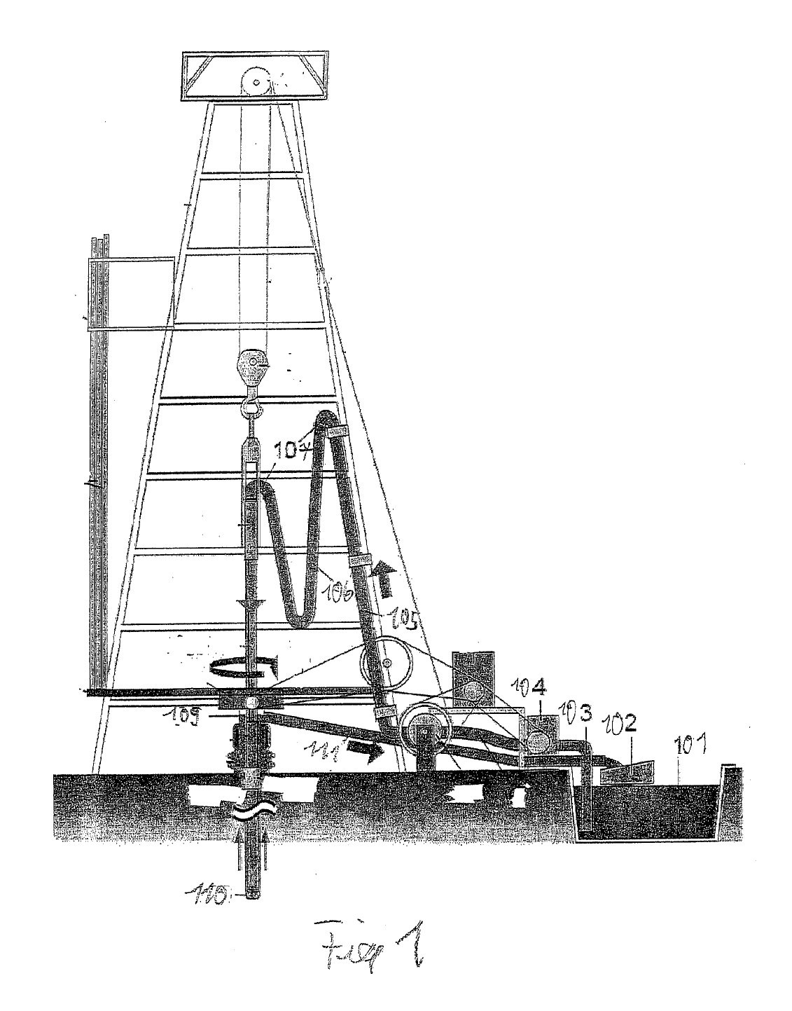

FIG. 1 schematically shows a drill rig as it may be when drilling oil or gas. In FIG. 1 primarily the parts which are a part of the fluid circulation are shown and will be explained in more detail. A mud tank or drilling fluid tank 101 is shown as a simple open pool however it may also be formed by a closed tank. The drilling fluid tank provides a reserve store for the drilling fluid. From the drilling fluid tank 101 the drilling fluid, e.g. a drilling fluid based on an ionic liquid is pumped through a suction line 103 by a pump 104. After passing the suction line 103 and the pump 104 the drilling fluid is pumped through a stand pipe 105 which is formed by a thick metal tubing. To the stand pipe 108 a first goose neck 107 is connected which is formed by a thick metal elbow and provides support to a kelly hose 106 which is a flexible high pressure hose which allows vertical movement of the drill rods in co-operation with a second goose neck 107. After passing the second goose neck the drilling fluid is pumped to the end of the borehole a drill bit 110. At the end of the borehole the drilling fluid cools the drilling bit and further washes out the debris the drilling bit removes. After cooling the drill bit and removing the debris the drilling fluid flows back to the surface due to the pressure exerted by the new drilling fluid. A so called bell nipple 109 forms an outlet for drilling fluid and allows the drilling fluid to flew, via a flow line 111, back to the drilling fluid tank. Before flowing into the tank the drilling fluid larger debris may be removed by a shale shaker 102. Furthermore, the used drilling fluid may be reconditioned or purified so that it may be used a second time.

The ionic liquid being part of the drilling fluid or even form the main component of the drilling fluid may be designed according to the specific needs. In general the ionic liquid may satisfy the generic formula ([A]₊)ₐ[B]a⁻, wherein [A]⁺ is one out the group consisting of quaternary ammonium cation [R^{1′}R¹R²R³N]⁺, phosphonium [R^{1′}R¹R²R³P]⁺, sulfonium [R^{1′}R¹R²S]⁺ and a hetero aromatic cation. In particular:

R¹, R^{1′}, R², R³ may be alkyl, alkenyl, alkinyl, cycloalkyl, cycloalkenyl, aryl or heteroaryl which may be independently substituted, or

two of the moieties R¹, R^{1′}, R², R³ may form a ring together with a hetero-atom to which they are bound. The ring may be saturated, unsaturated, substituted or unsubstituted. The chain may be interrupted by one or more hetero-atoms out of the group consisting of O, S, NH or N—C₁C₄-alkyl, and

[B]^{a-} may be an arbitrarily chosen anion having negative charge a.

Heteroaromate may be 5 or 6 membered rings comprising at least one N and if necessary one O and/or one S. The heteroaromate may be substituted or unsubstituted and/or annelated. Preferably, the heteroaromate is selected from the group consisting of:

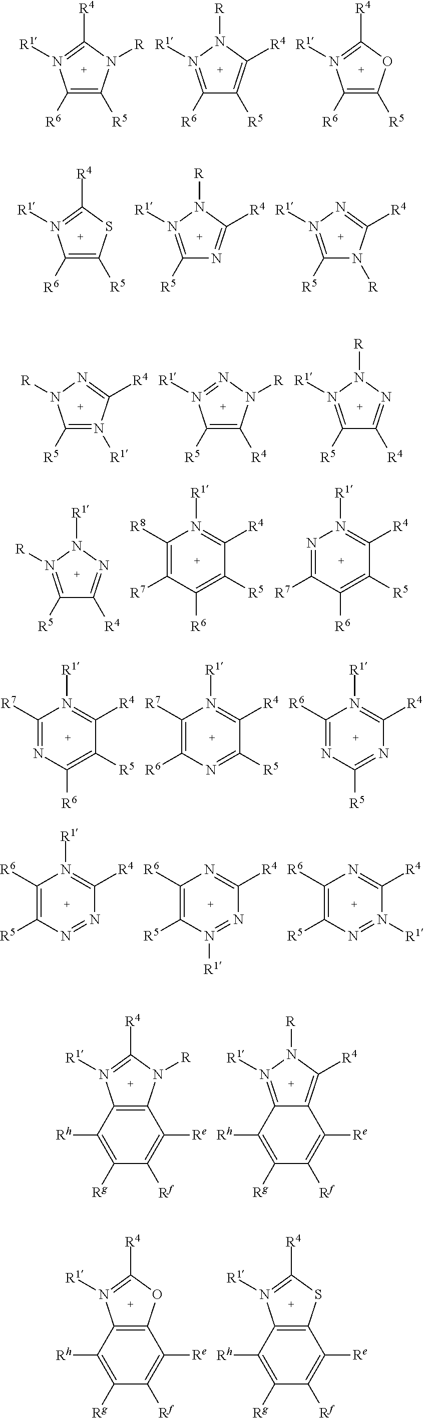

wherein the moieties R may be one of the following:

R hydrogen, C₁-C₃₀-alkyl, C₃-C₁₂-cycloalkyl, C₂-C₃₀-alkenyl, C₃-C₁₂-cycloalkenyl, C₂-C₃₀-alkinyl, aryl or heteroaryl, wherein the latter 7 moieties may have one or more halogenic moiety and/or 1 to 3 moieties selected from the group consisting of C₁-C₆-alkyl, aryl, heteroaryl, C₃-C₇-cycloalkyl, halogen, OR^{C}, SR^{C}, NR^{C}R^{d}, COR^{C}, COOR^{C}, CO—NR^{C}R^{d}, wherein R^{C} and R^{d} may be hydrogen, C₁-C₆-alkyl, C₁-C₆-halogenalkyl, cyclopentyl, cyclohexyl, phenyl, tolyl or benzyl;

R¹, R^{1′}, R², R³ may be hydrogen, alkyl, alkenyl, alkinyl, cycloalkyl, cycloalkenyl, aryl or heteroaryl which may be independently substituted; or

two of the moieties R¹, R^{1′}, R², R³ may form a ring together with a hetero-atom to which they are bound. The ring may be saturated, unsaturated, substituted or unsubstituted. The chain may be interrupted by one or more hetero-atoms out of the group consisting of O, S, NH or N—C₁-C₄-alkyl;

R⁴, R⁵, R⁶, R⁷, R⁸ may be, independently of each other, hydrogen, halogen, nitro, cyano, OR^{C}, SR^{C}, NR^{C}R^{d}, COR^{C}, COOR^{C}, CO—NR^{C}R^{d}, C₁-C₃₀-alkyl, C₃-C₁₂-cycloalkyl, C₂-C₃₀-alkenyl, C₃-C₁₂-cycloalkenyl, aryl or heteroaryl, wherein the latter 6 moieties may comprise one or more halogenic moiety and/or 1 to 3 moieties selected out of the group consisting of C₁-C₆-alkyl, aryl, heteroaryl, C₃-C₇cycloalkyl, halogen, OR^{C}, SR^{C}, NR^{C}R^{d}, COR^{C}, COOR^{C}, CO—NR^{C}R^{d} wherein R^{C} and R^{d} R^{d} may be, independently of each other, hydrogen, C₁-C₆-alkyl, C₁-C₆-halogenalkyl, cyclopentyl, cyclohexyl, phenyl, tolyl or benzyl; or

two neighboring moieties of the moieties R, R⁴, R⁵, R⁶, R⁷, R⁸, may form, together with an atom they are bound, a ring which may be unsaturated or aromatic, unsaturated or saturated, wherein the chain formed by the respective moieties may be interrupted by one or more hetero-atoms out of the group consisting of O, S, NH or N—C₁-C₄-alkyl;

R^{e}, R^{f}, R^{g}, R^{h} may be, independently of each other, hydrogen, C₁-C₆-alkyl, aryl-, heteroaryl-, C₃-C₇-cycloalkyl, halogen, OR^{c}, SR^{c}, NR^{c}R^{d}, COOR^{c}, CO—NR^{c}R^{d} or COR^{c}, wherein R^{c}, R^{d}, may be, independently of each other, hydrogen, C₁-C₆-alkyl, C₁-C₆-halogenalkyl, cyclopentyl, cyclohexyl, phenyl, tolyl or benzyl; preferably for hydrogen, halogen, C₁-C₆-alkyl, in particular, hydrogen or C₁-C₆-alkyl.

[B]^{a-} may be:

Fluoride, chloride, bromide, iodide; hexafluorophosphate; hexafluoroarsenate; hexafluoroantimonate; trifluoroarsenate; nitrite; nitrate; sulfate; hydrogensulfate; carbonate; hydrogencarbonate; alkylcarbonate; arylcarbonate; phosphate; hydrogenphosphate; dihydrogenphosphate; tetra-substituted borate of the generic form der (Va) [BRⁱR^{j}R^{k}R^{l}]⁻, wherein Rⁱ to R^{l} may be, independently of each other, fluorine or an organic, inorganic, acyclic, cyclic, aliphatic, aromatic or araliphatic moiety comprising carbon having 1 to 30 carbon atoms, which moiety may comprise one or more heteroatoms and/or which may be substituted by one or more functional groups or halogen;

organic sulfonate of the generic form (Vb) [R^{m}—SO₃]⁻, wherein R^{m} may be, one or more organic, saturated, unsaturated, acyclic, cyclic, aliphatic, aromatic or araliphatic moiety comprising carbon having 1 to 30 carbon atoms, which moiety may comprise one or more heteroatoms and/or which may be substituted by one or more functional groups or halogen; organic sulfonate of the generic form (Vc) [R^{m}—OSO₃]⁻, wherein R^{m} may be one organic, saturated, unsaturated, acyclic, cyclic, aliphatic, aromatic or araliphatic moiety comprising carbon having 1 to 30 carbon atoms, which moiety may comprise one or more heteroatoms and/or which may be substituted by one or more functional groups or halogen; carboxylate of the generic form (Vd) [R^{m}—COO]⁻, wherein Rⁿ may be one organic, saturated, unsaturated, acyclic, cyclic, aliphatic, aromatic or araliphatic moiety comprising carbon or hydrogen and having 1 to 30 carbon atoms, which moiety may comprise one or more heteroatoms and/or which may be substituted by one or more functional groups or halogen;

(fluoroalkyl)fluorophosphate of the generic form (Ve) [PFₓ(C_{y}F_{2y+1-z}H_{z})₆₋ₓ]₋, wherein 1≦x≦6, 1≦x≦8 and 0≦z≦2y+1; or

imide of the generic form (Vf) [R^{O}—SO₂—N—SO₂—R^{P}]⁻, (Vg) [R^{r}—SO₂—N—CO—R^{s}]⁻ or (Vh) [R^{t}—CO—N—CO—R^{u}]⁻, wherein R^{O} bis R^{u} may be, independently of each other, an organic, saturated, unsaturated, acyclic, cyclic, aliphatic, aromatic or araliphatic moiety comprising carbon or hydrogen and having 1 to 30 carbon atoms, which moiety may comprise one or more heteroatoms and/or which may be substituted by one or more functional groups or halogen.

Organic phosphate of the generic form (Vi) [R^{m}—OPO₄]²⁻ or (Vj) [R^{m}—OPO₂—ORⁿ]⁻ wherein R^{m} may be an organic, saturated, unsaturated, acyclic, cyclic, aliphatic, aromatic or araliphatic moiety comprising carbon and having 1 to 30 carbon atoms, which moiety may comprise one or more heteroatoms and/or which may be substituted by one or more functional groups or halogen, and wherein Rⁿ may be an organic, saturated, unsaturated, acyclic, cyclic, aliphatic, aromatic or araliphatic moiety comprising carbon or hydrogen and having 1 to 30 carbon atoms, which moiety may comprise one or more heteroatoms and/or which may be substituted by one or more functional groups or halogen.

The charge “a−” of the anion [B]^{a-} may be “1−”, “2−” or “3−”. Examples for anions having a double negative charge may be sulfate, hydrogenphosphate and carbonate while an example for anions having a triple negative charge may be phosphate.

The moieties Rⁱ to R^{l} in the tetra-substituted borate (Va), the moiety R^{m} of the organic sulfonate (Vb) and the organic sulfonate (Vc), the moiety Rⁿ of the carboxylate (Vd), and the moieties R^{O} to R^{u} of the imides (Vf), (Vg) and (Vh) may be, independently of each other, organic, saturated, unsaturated, acyclic, cyclic, aliphatic, aromatic or araliphatic moieties comprising carbon and having 1 to 30 carbon atoms:

C₁- to C₃₀-alkyl and the respective aryl-, heteroaryl-, cycloalkyl-, halogen-, hydroxy-, amino-, carboxy-, formyl-, —O—, —CO—, —CO—O— or —CO—N<substituted components, for example, methyl, ethyl, 1-propyl, 2-propyl, 1-butyl, 2-butyl, 2-methyl-1-propyl(isobutyl), 2-methyl-2-propyl(tert.-butyl), 1-pentyl, 2-pentyl, 3-pentyl, 2-methyl-1-butyl, 3-methyl-1butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3 dimethyl-2-butyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, triacontyl, phenylmethyl(benzyl), diphenylmethyl, triphenylmethyl, 2-phenylethyl, 3-phenylpropyl, cyclopentylmethyl, 2-cyclopentylethyl, 3-cyclopentylpropyl, cyclohexylmethyl, 2-cyclohexylethyl, 3-cyclohexylpropyl, methoxy, ethoxy, formyl, acetyl or CₙF_{2(n-a)+(1-b)}H_{2a+b} wherein n≦30, 0≦a≦n and b=0 or 1 (e.g. CF₃, C₂F₅, CH₂CH₂—C₍ₙ₋₂₎F₂₍ₙ₋₂₎₊₁, C₆F₁₃, C₈F₁₇, C₁₀F₂₁, C₁₂F₂₅);

C₃- to C₁₂-cycloalkyl and the respective aryl-, heteroaryl-, cycloalkyl-, halogen-, hydroxy-, amino-, carboxy-, formyl-, —O—, —CO— or —CO—O— substituted components, e.g. cyclopentyl, 2-methyl-1-cyclopentyl, 3-methyl-1-cyclopentyl, cyclohexyl, 2-methyl-1-cyclohexyl, 3-methyl-1-cyclohexyl, 4-methyl-1-cyclohexyl or CₙF_{2(n-a)-(1-b)}H_{2a-b} wherein n≦30, 0≦a≦n and b=0 or 1;

C₂- to C₃₀-alkenyl and the respective aryl-, heteroaryl-, cycloalkyl-, halogen-, hydroxy-, amino-, carboxy-, formyl-, —O—, —CO— or —CO—O substituted components, e.g. 2-propenyl, 3-butenyl, cis-2-butenyl, trans-2-butenyl or CₙF_{2(n-a)-(1-b)}H_{2a-b} wherein n≦30, 0≦a≦n and b=0 or 1;

C₃- to C₁₂-cycloalkenyl and the respective aryl-, heteroaryl-, cycloalkyl-, halogen-, hydroxy-, amino-, carboxy-, formyl-, —O—, —CO— or —CO—O— substituted components, e.g. 3-cyclopentenyl, 2-cyclohexenyl, 3-cyclohexenyl, 2,5-cyclohexadienyl or CₙF_{2(n-a)-3(1-b)}H_{2a-3b} wherein n≦30, 0≦a≦n and b=0 or 1; and

aryl or heteroaryl having 2 to 30 carbon atoms and the respective alkyl-, aryl-, heteroaryl-, cycloalkyl-, halogen-, hydroxy-, amino-, carboxy-, formyl-, —O—, —CO— or —CO—O— substituted components, e.g. phenyl, 2-methyl-phenyl(2-tolyl), 3-methyl-phenyl(3-tolyl), 4-methylphenyl, 2-ethyl-phenyl, 3-ethyl-phenyl, 4-ethyl-phenyl, 2,3-dimethyl-phenyl, 2,4-dimethyl-phenyl, 2,5-dimethyl-phenyl, 2,6-dimethyl-phenyl, 3,4-dimethyl-phenyl, 3,5-dimethyl-phenyl, 4-phenyl-phenyl, 1-naphthyl, 2-naphthyl, 1-pyrrolyl, 2-pyrrolyl, 3-pyrrolyl, 2-pyridinyl, 3-pyridinyl, 4-pyridinyl or C₆F₍₅₋ₐ₎Hₐ wherein 0≦a≦5.

In the case that anion [B]^{a-} is a tetra-substituted borate (Va) [BRⁱR^{j}R^{k}R^{l}]⁻, all four moieties Rⁱ to R^{l} may be preferably identical, in fluoro, trifluoromethyl, pentafluoroethyl, phenyl, 3,5-bis(trifluoromethyl)phenyl. Preferred tetra-substituted borate (Va) may be tetrafluoroborate, tetraphenylborate and tetra[3,5-bis(trifluoromethyl)phenyl]borate.

In case that the anion [B]^{a-} is an organic sulfonate (Vb) [R^{m}—SO₃]⁻ or sulfate (Vc) [R^{m}—OSO₃]⁻ the moiety R^{m} may be preferably methyl, trifluoromethyl, pentafluoroethyl, p-tolyl or C₉F₁₉. Preferred organic sulfonates (Vb) may be trifluoromethanesulfonate (triflate), methanesulfonate, nonadecafluorononansulfonate (nonaflate) and p-toluolsulfonate; while preferred organic sulfonates (Vc) may be methylsulfate, ethylsulfate, n-propylsulfate, i-propylsulfate, butylsulfate, pentylsulfate, hexylsulfate, heptylsulfate, octylsulfate, nonylsulfate and decylsulfate as well as long-chain n-alkylsulfate; benzylsulfate, and alkylarylsulfate.

In case that the anion [B]^{a-} is a carboxylate (Vd) [Rⁿ—COO]⁻, the moiety Rⁿ may be preferably hydrogen, trifluoromethyl, pentafluoroethyl, phenyl, hydroxy-phenyl-methyl, trichloromethyl, dichloromethyl, chloromethyl, trifluoromethyl, difluoromethyl, fluoromethyl or unbranched or branched C₁- to C₁₂-alkyl, e.g. methyl, ethyl, 1-propyl, 2-propyl, 1-butyl, 2-butyl, 2-methyl-1-propyl(isobutyl), 2-methyl-2-propyl(tert.-butyl), 1-pentyl, 2-pentyl, 3-pentyl, 2-methyl-1-butyl, 3-methyl-1butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, nonyl, decyl, undecyl or dodecyl. Preferred carboxylate (Vc) may be formate, acetate, propionate, butyrate, valeriate, benzoate, mandelate, trichloroacetate, dichloroacetate, chloroacetate, trifluoroacetate, difluoroacetate, fluoroacetate.

In case that the anion [B]^{a-} is a (fluoroalkyl)fluorophosphate (Ve) [PFₓ(C_{y}F_{2y+1-z}H_{z})₆₋ₓ]⁻, z may be preferably O. Preferred (fluoroalkyl)fluorophosphates (Ve) may be Ve wherein z=0, x=3 and 1≦Y≦4, in particular [PF₃(CF₃)₃]⁻, [PF₃(C₂F₅)₃]⁻, [PF₃(C₃F₇)₃]⁻ and [PF₃(C₄F₇)₃]⁻.

In case that the anion [B]^{a-} is an imide (Vf) [RO—SO2-N—SO2-RP]⁻ (Vg) [R^{r}—SO₂—N—CO—R^{s}]⁻ or (Vh) [R^{t}—CO—N—CO—R^{u}]⁻ the moieties R^{O} to R^{u} may be, independently of each other, preferably hydrogen, trifluoromethyl, pentafluoroethyl, phenyl, trichloromethyl, dichloromethyl, chloromethyl, trifluoromethyl, difluoromethyl, fluoromethyl or unbranched or branched C₁- to C₁₂-alkyl, e.g. methyl, ethyl, 1-propyl, 2-propyl, 1-butyl, 2-butyl, 2-methyl-1-propyl(isobutyl), 2-methyl-2-propyl(tert.-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, nonyl, decyl, undecyl or dodecyl. Preferred imides (Vf), (Vg) and (Vh) may be [F₃C—SO₂—N—SO₂—CF₃]⁻, [F₃C—SO₂—N—CO—CF₃]⁻, [F₃C—CO—N—CO—CF₃]⁻ and those wherein the moieties Reste R^{O} to R^{u} may be, independently of each other, hydrogen, methyl, ethyl, propyl, butyl, phenyl, trichloromethyl, dichloromethyl, chloromethyl, trifluoromethyl, difluoromethyl or fluoromethyl.

According to specific exemplary embodiments the ionic liquid contained in the drilling fluid may satisfy the generic form: [A]⁺[M^{+v}X_{V+1}]⁻ or ([A]⁺)₂[M^{+v}Xᵥ₊₂]²⁻ or ([A]⁺)₃[M^{+v}Xᵥ₊₃]³⁻, wherein [A]⁺ may be, as described above, one out the group consisting of quaternary ammonium cation [R^{1′}R¹R²R³N]⁺, phosphonium [R^{1′}R¹R²R³P]⁺, sulfonium [R^{1′}R¹R²S]⁺ and a hetero aromatic cation. In particular:

R¹, R^{1′}, R², R³ may be alkyl, alkenyl, alkinyl, cycloalkyl, cycloalkenyl, aryl or heteroaryl which may be independently substituted, or

two of the moieties R¹, R^{1′}, R², R³ may form a ring together with a hetero-atom to which they are bound. The ring may be saturated, unsaturated, substituted or unsubstituted. The chain may be interrupted by one or more hetero-atoms out of the group consisting of O, S, NH or N—C₁-C₄-alkyl, and

M^{+V} may be an atom of a transition metal having oxidation number of +v and X may be an ion or a ligand having a charge number of −1. Preferred transition metals may be Ti, V, Cr, Mn, Fe, Co, Ni, Cu, Zn, Mo, W, Sn, In, Sb, Al, or Pb, more preferably Ti, Mn, Fe, Cu, Al, or Sn.

Each one of the v+1, v+2, or v+3 ions or ligands may be selected, independently of each other, out of the following:

Fluoride, chloride, bromide, iodide; thiocyanate, hexafluorophosphate; hexafluoroarsenate; hexafluoroantimonate; trifluoroarsenate; nitrite; nitrate; sulfate; hydrogensulfate; carbonate; hydrogencarbonate; alkylcarbonate; arylcarbonate; phosphate; hydrogenphosphate; dihydrogenphosphate; tetra-substituted borate of the generic form der (Va) [BRⁱR^{j}R^{k}R^{l}]⁻ wherein Rⁱ to R^{l} may be, independently of each other, fluorine or an organic, inorganic, acyclic, cyclic, aliphatic, aromatic or araliphatic moiety comprising carbon having 1 to 30 carbon atoms, which moiety may comprise one or more heteroatoms and/or which may be substituted by one or more functional groups or halogen;

organic sulfonate of the generic form (Vb) [R^{m}—SO₃]⁻, wherein R^{m} may be one organic, saturated, unsaturated, acyclic, cyclic, aliphatic, aromatic or araliphatic moiety comprising carbon having 1 to 30 carbon atoms, which moiety may comprise one or more heteroatoms and/or which may be substituted by one or more functional groups or halogen;

organic sulfonate of the generic form (Vc) [R^{m}—OSO₃]⁻, wherein R^{m} may be one organic, saturated, unsaturated, acyclic, cyclic, aliphatic, aromatic or araliphatic moiety comprising carbon having 1 to 30 carbon atoms, which moiety may comprise one or more heteroatoms and/or which may be substituted by one or more functional groups or halogen;

carboxylate of the generic form (Vd) [Rn—COO]⁻, wherein Rⁿ may be one organic, saturated, unsaturated, acyclic, cyclic, aliphatic, aromatic or araliphatic moiety comprising carbon or hydrogen and having 1 to 30 carbon atoms, which moiety may comprise one or more heteroatoms and/or which may be substituted by one or more functional groups or halogen;

(fluoroalkyl)fluorophosphate of the generic form (Ve) [PFₓ(C_{y}F_{2y+1-z}Hz)₆₋ₓ]⁻ wherein 1≦x≦6, 1≦y≦8 and 0≦z≦2y+1; or

imide of the generic form (Vf) [R^{O}—SO₂—N—SO₂—R^{P}]⁻, (Vg) [R^{r}—SO₂—N—CO—R^{s}]⁻ or (Vh) [R^{t}—CO—N—CO—R^{u}]⁻, wherein R^{O} bis R^{u} may be, independently of each other, an organic, saturated, unsaturated, acyclic, cyclic, aliphatic, aromatic or araliphatic moiety comprising carbon or hydrogen and having 1 to 30 carbon atoms, which moiety may comprise one or more heteroatoms and/or which may be substituted by one or more functional groups or halogen.

Organic phosphate of the generic form (Vi) [R^{m}—OPO₄]²⁻ or (Vj) [R^{m}—OPO₂—ORⁿ]⁻ wherein R^{m} may be an organic, saturated, unsaturated, acyclic, cyclic, aliphatic, aromatic or araliphatic moiety comprising carbon and having 1 to 30 carbon atoms, which moiety may comprise one or more heteroatoms and/or which may be substituted by one or more functional groups or halogen, and wherein Rⁿ may be an organic, saturated, unsaturated, acyclic, cyclic, aliphatic, aromatic or araliphatic moiety comprising carbon or hydrogen and having 1 to 30 carbon atoms, which moiety may comprise one or more heteroatoms and/or which may be substituted by one or more functional groups or halogen.

The moieties Rⁱ to R^{l} in the tetra-substituted borate (Va), the moiety R^{m} of the organic sulfonate (Vb) and the organic sulfonate (Vc), the moiety Rⁿ of the carboxylate (Vd), and the moieties R^{O} to R^{u} of the imides (Vf), (Vg) and (Vh) may be, independently of each other, organic, saturated, unsaturated, acyclic, cyclic, aliphatic, aromatic or araliphatic moieties comprising carbon and having 1 to 30 carbon atoms:

C₁- to C₃₀-alkyl and the respective aryl-, heteroaryl-, cycloalkyl-, halogen-, hydroxy-, amino-, carboxy-, formyl-, —O—, —CO—, —CO—O— or —CO—N<substituted components, for example, methyl, ethyl, 1-propyl, 2-propyl, 1-butyl, 2-butyl, 2-methyl-1-propyl(isobutyl), 2-methyl-2-propyl(tert.-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, triacontyl, phenyl methyl(benzyl), diphenylmethyl, triphenylmethyl, 2-phenylethyl, 3-phenylpropyl, cyclopentylmethyl, 2-cyclopentylethyl, 3-cyclopentylpropyl, cyclohexylmethyl, 2-cyclohexylethyl, 3-cyclohexylpropyl, methoxy, ethoxy, formyl, acetyl or CₙF_{2(n-a)+(1-b)}H_{2a+b} wherein n≦30, 0≦a≦n and b=0 or 1 (e.g. CF₃, C₂F₅, CH₂CH₂—C₍ₙ₋₂₎F₂₍ₙ₋₂₎₊₁, C₆F₁₃, C₈F₁₇, C₁₀F₂₁, C₁₂F₂₅);

C₃- to C₁₂-cycloalkyl and the respective aryl-, heteroaryl-, cycloalkyl-, halogen-, hydroxy-, amino-, carboxy-, formyl-, —O—, —CO— or CO—O— substituted components, e.g. cyclopentyl, 2-methyl-1-cyclopentyl, 3-methyl-1-cyclopentyl, cyclohexyl, 2-methyl-1-cyclohexyl, 3-methyl-1-cyclohexyl, 4-methyl-1-cyclohexyl or CₙF_{2(n-a)-(1-b)}H_{2a-b} wherein n≦30, 0≦a≦n and b=0 or 1;

C₂- to C₃₀-alkenyl and the respective aryl-, heteroaryl-, cycloalkyl-, halogen-, hydroxy-, amino-, carboxy-, formyl-, —O—, —CO— or —CO—O— substituted components, e.g. 2-propenyl, 3-butenyl, cis-2-butenyl, trans-2-butenyl or CₙF_{2(n-a)-(1-b)}H_{2a-b} wherein n≦30, 0≦a≦n and b=0 or 1;

C₃- to C₁₂-cycloalkenyl and the respective aryl-, heteroaryl-, cycloalkyl-, halogen-, hydroxy-, amino-, carboxy-, formyl-, —O—, —CO— or —CO—O— substituted components, e.g. 3-cyclopentenyl, 2-cyclohexenyl, 3-cyclohexenyl, 2,5-cyclohexadienyl or CₙF_{2(n-a)-3(1-b)}H_{2a-3b} wherein n≦30, 0≦a:5≦n and b=0 or 1; and

aryl or heteroaryl having 2 to 30 carbon atoms and the respective alkyl-, aryl-, heteroaryl-, cycloalkyl-, halogen-, hydroxy-, amino-, carboxy-, formyl-, —O—, —CO— or —CO—O— substituted components, e.g. phenyl, 2-methyl-phenyl(2-tolyl), 3-methyl-phenyl(3-tolyl), 4-methyl-phenyl, 2-ethyl-phenyl, 3-ethyl-phenyl, 4-ethyl-phenyl, 2,3-dimethyl-phenyl, 2,4-dimethyl-phenyl, 2,5-dimethyl-phenyl, 2,6-dimethyl-phenyl, 3,4-dimethyl-phenyl, 3,5-dimethyl-phenyl, 4-phenyl-phenyl, 1-naphthyl, 2-naphthyl, 1-pyrrolyl, 2-pyrrolyl, 3-pyrrolyl, 2-pyridinyl, 3-pyridinyl, 4-pyridinyl or C₆F₍₅₋ₐ₎Hₐ wherein 0≦a≦5.

In the case that X is a terta-substituted borate (Va) [BRⁱR^{j}R^{k}R^{l}]⁻, all four moieties Rⁱ to R^{l} may be preferably identical, fluoride, trifluoromethyl, pentafluoroethyl, phenyl, 3,5-bis(trifluoromethyl)phenyl. Preferred tetra-substituted borate (Va) may be tetrafluoroborate, tetra phenyl borate and tetra[3,5-bis(trifluoromethyl)phenyl]borate.

In case that X is an organic sulfonate (Vb) [R^{m}—SO₃]⁻ or sulfate (Vc) [R^{m}—OSO₃]⁻ the moiety R^{m} may be preferably methyl, trifluoromethyl, pentafluoroethyl, p-tolyl or C₉F₁₉. Preferred organic sulfonates (Vb) may be trifluoromethanesulfonate (triflate), methanesulfonate, nonadecafluorononansulfonate (nonaflate) and p-toluolsulfonate; while preferred organic sulfonates (Vc) may be methylsulfate, ethylsulfate, npropylsulfate, i-propylsulfate, butylsulfate, pentylsulfate, hexylsulfate, heptylsulfate, octylsulfate, nonylsulfate and decylsulfate as well as longchain n-alkylsulfate; benzylsulfate, and alkylarylsulfate.

In case that X is a carboxylate (Vd) [Rⁿ—COO]⁻, the moiety Rⁿ may be preferably hydrogen, trifluoromethyl, pentafluoroethyl, phenyl, hydroxy-phenyl-methyl, trichloromethyl, dichloromethyl, chloromethyl, trifluoromethyl, difluoromethyl, fluoromethyl or unbranched or branched C₁- to C₁₂-alkyl, e.g. methyl, ethyl, 1-propyl, 2-propyl, 1-butyl, 2-butyl, 2-methyl-1-propyl(isobutyl), 2-methyl-2-propyl(tert.-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3dimethyl-2-butyl, heptyl, octyl, nonyl, decyl, undecyl or dodecyl. Preferred carboxylate (Vc) may be formate, acetate, propionate, butyrate, valeriate, benzoate, mandelate, trichloroacetate, dichloroacetate, chloroacetate, trifluoroacetate, difluoroacetate, fluoroacetate.

In case that X is a (fluoroalkyl)fluorophosphate (Ve) [PFₓ(C_{y}F_{2y+1-z}H_{z})₆₋ₓ]⁻, z may be preferably 0. Preferred (fluoroalkyl)fluorophosphates (Ve) may be Ve wherein z=0, x=3 and 1≦y≦4, in particular [PF₃(CF₃)₃]⁻, [PF₃(C₂F₅)₃]⁻, [PF₃(C₃F₇)₃]⁻ and [PF₃(C₄F₇)₃]⁻.

In case that X is an imide (Vf) [R^{O}—SO₂—N—SO₂—R^{P}]⁻, (Vg) [R^{r}—SO₂—N—CO—R^{s}]⁻ or (Vh) [R^{t}—CO—N—CO—R^{u}]⁻ the moieties R^{O} to R^{u} may be, independently of each other, preferably hydrogen, trifluoromethyl, pentafluoroethyl, phenyl, trichloromethyl, dichloromethyl, chloromethyl, trifluoromethyl, difluoromethyl, fluoromethyl or unbranched or branched C₁- to C₁₂-alkyl, e.g. methyl, ethyl, 1-propyl, 2-propyl, 1-butyl, 2-butyl, 2-methyl-1-propyl(isobutyl), 2-methyl-2-propyl(tert.-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, nonyl, decyl, undecyl or dodecyl. Preferred imides (Vf), (Vg) and (Vh) may be [F₃C—SO₂—N—SO₂—CF₃]⁻, [F₃C—SO₂—N—CO—CF₃]⁻, [F₃C—CO—N—CO—CF₃]⁻ and those wherein the moieties Rests R^{O} to R^{u} may be, independently of each other, hydrogen, methyl, ethyl, propyl, butyl, phenyl, trichloromethyl, dichloromethyl, chloromethyl, trifluoromethyl, difluoromethyl or fluoromethyl.

Each X may be selected, independently of each other, out of the following complex-ligands:

Acetylacetone; acyl; adenine; 2,2′-azobisisobutyronitrile; alanine; allyl; allyloxycarbonyl; water; aryl; arginine; asparagine; aspartate; BIABN; biotinyl; 2,2′-bis(diphenyl-phosphino)-6,6′-dimethoxy-1,1′ biphenyl; 2,2′-binaphtyldiphenyldiphosphine; 1,2-bis[4,5-dihydro-3H-binaphtho[1,2-c:2′,1′-e]phosphepino]benzene; 1,1′-bis{4,5-dihydro-3H-dinaphtho[1,2-c:2′,1′-e]phosphepino}ferrocene; 4,4′-di-tertbutyl-4,4′,5,5′-tetrahydro-3,3′-bis-3H-di-naphtho[2,1-c:1′,2′e]phosphepine; BINAL; 4,5-dihydro-3H-dinaphtho[2,1-c;1′,2′-e]phosphepine; 2,2′-binaphtyldiol; bis-tert-butyl-bipyridine; benzylmethylphenylphosphine; benzyl; tert-butoxycarbonyl; bis(2-((S)-4-iso-propyl-4,5-dihydroxazol-2-yl)phenyl)amine; 1,2-bis(2-((S)-4-tertbutyl-4,5-dihydroxazol-2-yl)phenyl)amine; 1,2-bis(2,5-diethyl-phospholano)-ethane; butoxy-carbonyl-4-diphenylphosphino-2-diphenylphosphino-methyl-pyrrolidine; 2,2′-bipyridine; benzoyl; benzyloxycarbonyl; CO; cycloheptatrienyl; citrulline; citrate; cyanide; cycloctadiene; cycloctatetraene; cyclopentadienyl; pentamethylcyclopentadienyl; cyclohexyl; cytidine; cysteine; cytosine; dibenzilidenacetone; O-isopropyliden-2,3-dihydroxy-1,4-bis(diphenyl phosphino)butane; (1R,2R)-bis[(2-methoxyphenyl)phenyl-phosphino]ethane; 4-dimethylaminopyridine; dimethylglyoxim dipivaloylmethanate; Dess-Martin periodinane; 1,4,7,10-tetraaza cyclododecan-1,4,7,10-tetraacetate; diphenylphosphenylethane; diphenylphosphenylmethane; diphenylphosphenylpropane; deoxyribose; diethylentriamin-pentaacetate; bis(2,5-dimethylphospholano)-benzene; ethylendiamintetraacetate; ethylendiamine; fluoroenylmethoxycarbonyl; 7,7-dimethyl-1,1,1,2,2,3,3-heptafluorooctan-4,6-dionato; galactose; galactosamine; N-acetylgalactosamine, glycolyl; glucose; glucosamine, N-acetyl-glucosamine, glutamine, glutamate, glycine, guanine; guanosine; hemoglobin; hexafluoroacetylacetonate; histidine; hexamethylphosphorsauretriamide; hydroxyproline; isoleucine; leucine; lysine; 2,2′-bis[(N,N-dimethylamino)(phenyl)methyl]-1,1′bisdicyclohexyl-phosphino)ferrocene; myoglobin; methionine; methemoglobin; metmyoglobin; 3,5-dioxa-4-phosphacyclohepta[2,1-a;3,4-a′]dinapthalen-4-yl)dimethylamine; methylphenyln-propyl-phosphine; methylsulfone; bicyclo[2.2.1]hepta-2,5-; neuraminic-acid; N-acetyl-neuraminic-acid; N-glycolyl-neuraminic-acid; 2,3-bis(diphenylphosphino)-bicyclo[2. 2.1]hept-5-en; nitrilo-triacetic acid; ornithine; succinate; oxalate; phenyl o-anisylmethylphosphine; phthalocyanine; phenylalanine; phenanthroline; picolylamine; piperidine; para-nitro-benzoic acid; porphyrine; proline; pyridyl; PYBOX; pyroglutamate; pyrazine; ribose; sarcosine; salen; serin; succinyl; 1,4,7triazacyclononane; tert-butyl-di-methyl-silyl; tartrate; terpyridine; thymidine; threonine; thymine; tetramethylethylendiamine; trimesic acid; tris(pyrazolyl)borate; triphenylphosphane; tryptophane; tyrosine; tetrazole; ubiquitine; uracil; uridine; aline.

Finally, it should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. In a device claim enumerating several means, several of these means may be embodied by one and the same item of software or hardware. The mere fact that certain measures are recited in mutually different dependent claims does not indicate that a combination of these measures cannot be used to advantage.

1. A method of treating a borehole, the method comprises:
introducing a drilling fluid into a borehole, wherein the drilling fluid comprises an ionic liquid.

2. The method according to claim 1, wherein the drilling fluid comprises at least 20 mass percent of ionic liquid.

3. The method according to claim 1, wherein the drilling fluid comprises at least 95 mass percent of ionic liquid.

4. The method according to claim 1, wherein the ionic liquid has a density of more than 1.5.

5. The method according to claim 1, further comprising:
removing the drilling fluid out of the borehole,
reconditioning the removed drilling fluid, and
introducing the reconditioned drilling fluid in the borehole.

6. The method according to claim 1, wherein the drilling fluid has a temperature stability which is higher than a predetermined threshold value.

7. The method according to claim 1, wherein the drilling fluid has a water absorption capability which is lower than a predetermined threshold value.

8. The method according to claim 1, wherein the ionic liquid satisfies the generic formula ([A]⁺)ₐ[B]^{a-}, wherein [A]⁺ is one out the group consisting of quaternary ammonium cation [R^{1′}R¹R²R³N]⁺, phosphonium [R^{1′}R¹R²R³P]⁺, sulfonium [R^{1′}R¹R²S]⁺ and a hetero aromatic cation.

9. A drilling fluid which is based on ionic liquid.
